(19) United States
(12) Patent Application Publication
(10) Pub. No.: US 2022/0152988 A1
(43) Pub. Date: May 19, 2022

(54) VEHICLE COMPOSITE PANE COMPRISING A HEATABLE INLAY ELEMENT

(71) Applicant: SAINT-GOBAIN GLASS FRANCE, COURBEVOIE (FR)

(72) Inventors: Dirk WOHLFEIL, Raeren (BE); Gabor VARGA, Herzogenrath (DE); Christopher MATHEISEN, Herzogenrath (DE); Michael KOLF, Eschweiler (DE)

(21) Appl. No.: 17/440,494

(22) PCT Filed: Mar. 9, 2020
(86) PCT No.: PCT/EP2020/056162

§ 371 Date: Sep. 17, 2021

(30) Foreign Application Priority Data
Mar. 19, 2019 (EP) 19163659.6

(51) Int. Cl. B32B 17/10; B60J 1/20; B32B 27/36; B32B 27/32

(52) U.S. Cl. CPC B32B 17/10385; B32B 2323/04; B32B 17/10036; B32B 17/10348; B32B 27/36; B32B 27/32; B32B 17/10293; B32B 17/10935; B32B 2307/412; B32B 2307/41; B32B 2307/732; B32B 2255/205; B32B 2255/20; B32B 2255/26; B32B 2307/202; B32B 2605/08; B32B 2605/006; B32B 2367/00; B60J 1/20

(57) ABSTRACT

A vehicle composite pane includes a first pane and a second pane, which are joined to one another via at least one thermoplastic intermediate layer, and an inlay element, which is arranged between the first pane and the second pane. The inlay element includes an opaque layer that has at least one cutout, a transparent substrate layer, and a transparent electrically heatable layer.

The invention relates to a vehicle composite pane with a heatable inlay element, a method for its production, and its use.

Modern vehicles are equipped with an increasing number of optical sensors whose signals are used to assist the driver. Examples of such sensors are cameras such as video cameras or night vision cameras, rain sensors, light sensors, or distance meters. Forward directed sensors are frequently secured on the interior-side surface of the windshield, typically centrally in the vicinity of the upper edge. In the prior art, the sensors are obscured by an opaque masking print on the windshield. For this, the customary, peripheral, frame-like masking print, which primarily serves as UV protection for the assembly adhesive of the windshield, is significantly enlarged in the direction of the center of the pane in the region of the sensors.

Conventional sensors are mounted on the windshield such that their detection direction runs horizontally. Since the windshield is installed in the vehicle greatly inclined, for example, at an installation angle of 60° relative to the vertical, the detection direction of the sensor encloses a very acute angle of approx. 30° with the windshield. This yields a relatively large, substantially trapezoidal so-called “sensor window” of the windshield. The sensor window is that region of the windshield through which radiation passing through is detected by the sensor. The sensor window of the windshield is, thus, the region that lies in the detection beam path of the sensor.

The more sensors to be secured on the pane, the more area of the windshield is occupied by the total of the sensor regions, and the larger the masking print intended to obscure the sensors has to be.

During the production of a vehicle composite pane, the masking print is applied on the outer pane or the inner pane by screen printing before the bending of the individual panes. During the bending process, which is usually carried out at temperatures from 500° C. to 700° C., the heat is absorbed more by the screen print than by the respective pane. This can result in optical distortions of sensor windows surrounded by screen printing, in particular black printing, and/or in glass breakage.

The sensor windows should be kept free of ice or fog. This can be made possible, for example, by heatable sensor windows. For this purpose, heating wires are laminated into the region of the sensor windows. Such laminated-in heating wires are, however, disadvantageous for the optical quality of the sensor windows.

DE 102 49 992 C1 and EP 2 977 202 A1 disclose composite panes with an electrically conductive layer and an opaque edge strip.

DE 10 2012 018 001 A1 discloses a heatable vehicle composite pane with a sensor window and an opaque masking print.

A pane with a heatable sensor field is disclosed in DE 10 2009 026 021 A1.

The object of the present invention is to provide an improved vehicle composite pane in which in particular the sensor windows are heatable and the optical quality of the sensor windows is improved and/or the risk of glass breakage during the bending process is reduced.

The object of the present invention is accomplished according to the invention by a vehicle composite pane in accordance with claim 1. Preferred embodiments are apparent from the subclaims.

The vehicle composite pane according to the invention comprises at least a first pane and a second pane that are joined to one another via at least one thermoplastic intermediate layer and an inlay element that is arranged between the first pane and the second pane.

According to the invention, the inlay element comprises an opaque layer that has at least one cutout, a transparent substrate layer, and a transparent electrically conductive layer.

According to the invention, the transparent electrically conductive layer is an electrically heatable layer, i.e., a layer that heats up when a voltage is applied.

Different sequences and embodiments of the layers in the inlay element are possible. The different layer sequences in the inlay element yield different embodiments of the vehicle composite pane according to the invention having such an inlay element.

In one embodiment of the vehicle composite pane according to the invention, the inlay element is constructed such that the transparent substrate layer is arranged between the opaque layer and the transparent electrically heatable layer.

In another embodiment, the layer structure of the inlay element is such that the transparent electrically heatable layer is arranged between the transparent substrate layer and the opaque layer.

In one embodiment, in the inlay element, the transparent substrate layer is surrounded by the opaque layer in a frame-like manner, i.e.; the transparent substrate layer is arranged completely within the at least one cutout of the opaque layer. In this embodiment, the transparent electrically heatable layer is arranged, over its entire surface, directly adjacent the opaque layer and the transparent substrate layer. It thus extends over the entire length and width of the inlay element, i.e., it has the same external dimensions as the opaque layer. If the opaque layer has more than one cutout, one subsection of the transparent substrate layer is arranged in each of these cutouts in this embodiment, wherein each of the subsections is surrounded by the opaque layer in a frame-like manner. It is also possible for the transparent substrate layer and the opaque layer to be implemented in one piece. This can, for example, be realized by the opaque colorization in certain regions of the transparent substrate layer. A separate opaque layer is then unnecessary in these embodiments.

The transparent substrate layer and the transparent electrically heatable layer can also be implemented in one piece as an electrically heatable transparent substrate layer. In one embodiment, in the inlay element, the opaque layer having at least one cutout is arranged directly adjacent the electrically heatable transparent substrate layer. In another embodiment, the opaque layer surrounds the electrically heatable transparent substrate layer, i.e., the electrically heatable transparent substrate layer is arranged completely within the cutout of the opaque layer. If the opaque layer has more than one cutout, in this embodiment, a subsection of the electrically heatable transparent substrate layer is arranged in each of these cutouts, wherein each of these subsections is surrounded by the opaque layer in a frame-like manner.

In one embodiment, in the inlay element, the opaque layer and the transparent electrically heatable layer are implemented in one piece as an electrically heatable opaque layer having at least one cutout, and the transparent substrate layer is arranged over the entire surface directly adjacent the electrically heatable opaque layer and the at least one cutout. It thus extends over the entire length and width of the inlay element, i.e., it has the same external dimensions as the electrically heatable opaque layer.

In another embodiment, in the inlay element, the opaque layer and the transparent electrically heatable layer are implemented in one piece as an electrically heatable opaque layer having at least one cutout, and the transparent substrate layer is arranged completely within the at least one cutout of the electrically heatable opaque layer. In other words, in this embodiment, the transparent substrate layer is surrounded in a frame-like manner by the electrically heatable opaque layer. If the electrically heatable opaque layer has more than one cutout, in this embodiment, a subsection of the transparent substrate layer is arranged in each of these cutouts, wherein each of these subsections is surrounded in a frame-like manner by the electrically heatable opaque layer.

The first pane and the second pane are typically made of glass. In this case, the first pane can be the outer pane; and the second pane, the inner pane of the vehicle composite pane according to the invention. Alternatively, the second pane can also be the outer pane; and the first pane, the inner pane of the vehicle composite pane according to the invention. The vehicle composite pane is intended for separating a vehicle interior from an external environment. The vehicle composite pane is thus a window pane that is inserted in a window opening of the vehicle body or is intended for this. The vehicle composite pane according to the invention is in particular a windshield of a motor vehicle.

The term “inner pane” refers to that pane that is intended to face the interior of the vehicle in the installed position. “Outer pane” refers to that pane that is intended to face the external environment of the vehicle in the installed position. As described above, in the vehicle composite pane according to the invention, the first pane can be the outer pane, and the second pane, the inner pane; or alternatively, the second pane can be the outer pane, and the first pane, the inner pane. That surface of the respective pane that faces the external environment in the installed position is referred to as the exterior-side surface. That surface of the respective pane that faces the interior of the vehicle in the installed position is referred to as the interior-side surface.

The region of the vehicle composite pane that is arranged in the detection beam path of a sensor or is intended for that purpose is referred to as the sensor region or sensor window. Radiation that passes through the vehicle composite pane in the sensor window is detected by the sensor.

When the sensor is a camera, the region of the vehicle composite pane that is arranged in the detection beam path or is intended for that purpose can also be referred to as the camera region or the camera window. Radiation that passes through the vehicle composite pane in the camera window is detected by the camera.

In a preferred embodiment of a vehicle composite pane according to the invention, the at least one cutout in the opaque layer of the inlay element is a sensor window for an optical sensor.

The vehicle composite pane according to the invention is in particular provided for and suitable for securing an optical sensor on the pane that is the inner pane in the installed position. For that purpose, the interior-side surface of the inner pane can be equipped with suitable mounts, for example, with a bracket or a housing.

The optical sensors are preferably cameras such as video cameras or night vision cameras, rain sensors, light sensors, distance meters, or LIDAR (light detection and ranging) systems. If there is more than one optical sensor, the type of the individual optical sensors can even be different.

In one embodiment, the vehicle composite pane additionally includes at least one optical sensor that is secured on the interior-side surface of the inner pane and is directed toward the at least one cutout. In through-vision through the vehicle composite pane from the outside, the sensor is preferably covered by the opaque layer or the electrically heatable opaque layer and is thus not visible from the outside.

Preferably, the number of cutouts in the opaque layer or the electrically heatable opaque layer corresponds to the number of optical sensors such that in each case one sensor is directed toward one cutout. However, it is also possible for the number of cutouts to be less than the number of sensors such that multiple sensors are directed toward the same cutout.

In one embodiment, the at least one cutout is trapezoidal. A trapezoidal cutout is in particular suitable as a sensor window for a camera. In another embodiment, the at least one cutout is circular or oval. A circular or oval cutout is in particular suitable as a sensor window for a rain sensor. When the opaque layer or the electrically heatable opaque layer has more than one cutout, they can even have different shapes.

The area of the at least one cutout corresponds at least to the size of the sensor window required for the respective sensors, preferably exactly to the size of the sensor window required for the respective sensors. The cutout preferably has an area of at least 1 cm², particularly preferably of 1 cm² to 500 cm², most particularly preferably of 10 cm² to 250 cm², in particular of 20 cm² to 100 cm², for example, 35 cm². When the opaque layer has more than one cutout, their areas can be different.

The first pane, the second pane, and the at least one thermoplastic intermediate layer usually have the same dimensions.

In terms of its dimensions, the inlay element is preferably smaller than the first pane, the second pane, and the at least one thermoplastic intermediate layer. For example, the inlay element only partially covers the panes. The area of the inlay element is, in one embodiment, at most 95%, preferably at most 75%, particularly preferably at most 50%, most particularly preferably at most 10% of the area of the vehicle composite pane.

In a preferred embodiment, the opaque layer of the inlay element contains polyethylene terephthalate (PET) or polyethylene (PE), in particular PET. In a particularly preferred embodiment, the opaque layer of the inlay element is made of polyethylene terephthalate (PET) or polyethylene (PE), in particular of PET.

It goes without saying that the opaque layer can also be implemented as an opaque coating of the transparent substrate layer or of the electrically heatable transparent substrate layer. Thus, the opaque layer implemented as an opaque coating differs from an opaque masking print applied to the first pane or the second pane. Suitable opaque coatings and printing methods for applying the opaque coating to the transparent substrate layer or to the electrically heatable transparent substrate layer are known to the person skilled in the art.

The opaque layer is preferably between 10 μm (microns) and 200 μm thick, particularly preferably between 100 μm and 200 μm, most particularly preferably between 125 μm and 180 μm. In preferred embodiments, the opaque layer is 125 μm or 150 μm thick.

In a preferred embodiment, the transparent substrate layer of the inlay element contains or is made of a thermoplastic or a thermosetting plastic. Alternatively, the transparent substrate layer can be a glass layer with a thickness less than or equal to 0.5 mm, preferably less than or equal to 0.2 mm, particularly preferably less than or equal to 0.1 mm.

Preferably, the transparent substrate layer contains or is made of ethylene vinyl acetate (EVA), polyvinyl butyral (PVB), polyurethane (PU), polyethylene terephthalate (PET), polyethylene (PE), or polyester or mixtures or copolymers or derivatives thereof. Particularly preferably, the transparent substrate layer contains or is made of polyethylene terephthalate (PET).

The transparent substrate layer is preferably between 10 μm and 500 μm thick, particularly preferably between 50 μm and 200 μm, most particularly preferably between 80 μm and 125 μm. The transparent substrate layer is, for example, 50 μm or 100 μm thick.

The transparent electrically heatable layer can be an electrically heatable coating, a carbon-containing layer, or a metallic layer. Alternatively, the transparent electrically heatable layer can contain or be made of a conductive polymer. It is known to the person skilled in the art which materials are suitable as transparent electrically heatable layers. For example, the transparent electrically heatable layer can be an indium tin oxide (ITO) layer or coating, a layer or coating containing silver or a silver-containing alloy, a layer or coating containing gold, aluminum, or tungsten, a graphite-containing layer or coating, or graphene. Examples of conductive and thus heatable polymers include poly-3,4-ethylenedioxythiophene (PEDOT) with polystyrene sulfonate (PSS) as counterion, doped polyacetylene (PAC), and polyaniline (PAni).

The transparent electrically heatable layer is preferably between 5 μm and 50 μm thick, particularly preferably between 5 μm and 20 μm, most particularly preferably between 8 μm and 15 μm. The transparent electrically heatable layer is, for example, 10 μm thick.

In embodiments in which the conductive element, i.e., the transparent electrically heatable layer, is applied as a coating, the conductive element, i.e., the transparent electrically heatable layer, is preferably between 10 nm and 5000 nm thick, preferably between 10 nm and 100 nm.

The electrically heatable transparent substrate layer can contain or be made of an electrically conductive polymer. Examples of conductive polymers include poly-3,4-ethylenedioxythiophene (PEDOT) with polystyrene sulfonate (PSS) as counterion, doped polyacetylene (PAC), and polyaniline (PAni).

The electrically heatable transparent substrate layer is preferably between 5 μm and 150 μm thick, particularly preferably between 10 μm and 100 μm, most particularly preferably between 50 μm and 100 μm. The electrically heatable transparent substrate layer is, for example, 50 μm or 100 μm thick.

The electrically heatable opaque layer can contain or be made of an electrically conductive polymer. Examples of conductive polymers include poly-3,4-ethylenedioxythiophene (PEDOT) with polystyrene sulfonate (PSS) as counter ion, doped polyacetylene (PAC), and polyaniline (PAni).

The electrically heatable opaque layer is preferably between 10 μm and 500 μm thick, particularly preferably between 100 μm and 200 μm, most particularly preferably between 125 μm and 180 μm. In preferred embodiments, the electrically heatable opaque layer is 125 μm or 150 μm thick.

In preferred embodiments, the opaque layer or the electrically heatable opaque layer is, at least in sections, transparent to infrared radiation having a wavelength in the range between 800 nm and 1100 nm. In these embodiments, the opaque layer or the electrically heatable opaque layer is thus transparent, at least in sections, to radiation of infrared sensors or light detection and ranging (LiDaR) sensors.

The at least one thermoplastic intermediate layer preferably contains ethylene vinyl acetate (EVA), polyvinyl butyral (PVB), or polyurethane (PU) or mixtures or copolymers or derivatives thereof, particularly preferably PVB. The thickness of the thermoplastic intermediate layer is preferably from 0.2 mm to 2 mm, particularly preferably from 0.3 mm to 1 mm, for example, 0.38 mm or 0.76 mm. Men the vehicle composite pane includes two or more thermoplastic intermediate layers, the individual intermediate layers can even be of different materials.

In one embodiment, the vehicle composite pane comprises a first pane and a second pane that are joined to one another via exactly one thermoplastic intermediate layer. In this case, the inlay element is arranged between the first pane and the thermoplastic intermediate layer or between the second pane and the thermoplastic intermediate layer.

In another embodiment, the vehicle composite pane comprises a first pane and a second pane that are joined to one another via at least two thermoplastic intermediate layers. In this case, the inlay element is preferably arranged between two of the thermoplastic intermediate layers.

In a preferred embodiment of a vehicle composite pane according to the invention, the opaque layer or the electrically heatable opaque layer is black. The opaque layer or the electrically heatable opaque layer can, however, also be any other color. The opaque layer or the electrically heatable opaque layer can also be implemented as a layer colored all the way through or as an imprinted layer.

A vehicle composite pane according to the invention can additionally include a masking print, in particular made of a dark; preferably black, enamel. Preferably, the opaque layer or the electrically heatable opaque layer and the masking print have substantially the same optical density. The masking print is in particular a peripheral, i.e.; frame-like, masking print. The peripheral masking print serves primarily as UV protection for the assembly adhesive of the vehicle composite pane. The masking print can be opaque and cover the entire surface. The masking print can also be implemented semitransparent, at least in sections, for example, as a point grid, a strip grid, or a checkered grid. Alternatively, the masking print can also have a gradient, for example, from an opaque covering to a semitransparent covering.

“Substantially the same optical density” means that the optical densities of two materials differ from one another by at most 5%, preferably by 3%, particularly preferably by at most 2%.

In a preferred embodiment of a vehicle composite pane according to the invention, it includes a masking print that is the same color as the opaque layer or the electrically heatable opaque layer.

The masking print is usually applied to the interior-side surface of that pane that constitutes the outer pane in the installed position or to the interior-side surface of that pane that constitutes the inner pane in the installed position.

In one embodiment, the vehicle composite pane comprises a first pane and a second pane that are joined to one another via exactly one thermoplastic intermediate layer; and a masking print is applied to the outer pane. In this case, the inlay element is preferably arranged between the outer pane and the thermoplastic intermediate layer; and the opaque layer or the electrically heatable opaque layer of the inlay element is particularly preferably arranged directly adjacent the outer pane.

In another embodiment, the vehicle composite pane comprises a first pane and a second pane that are joined to one another via exactly one thermoplastic intermediate layer; and a masking print is applied to the interior-side surface of the inner pane. In this case, the inlay element is preferably arranged between the inner pane and the thermoplastic intermediate layer; and the opaque layer or the electrically heatable opaque layer of the inlay element is particularly preferably arranged directly adjacent the inner pane.

In another embodiment, the vehicle composite pane comprises a first pane and a second pane that are joined to one another via two thermoplastic intermediate layers; and a masking print is applied to the interior-side surface of the inner pane. In this case, the inlay element is preferably arranged between the inner pane and the thermoplastic intermediate layer adjacent the inner pane or between the two thermoplastic intermediate layers.

In another embodiment, the vehicle composite pane comprises a first pane and a second pane that are joined to one another via two thermoplastic intermediate layers; and a masking print is applied to the interior-side surface of the outer pane. In this case, the inlay element is preferably arranged between the outer pane and the thermoplastic intermediate layer adjacent the outer pane or between the two thermoplastic intermediate layers.

Preferably, the opaque layer of the inlay element is, in each case, arranged between the first pane and the second pane as directly adjacent as possible to the pane to which the masking print is applied. In such an arrangement, in top view from the outside, the supply lines and connections of the transparent electrically heatable layer or the electrically heatable transparent substrate layer are concealed by the opaque layer. Alternatively, the supply lines and connections can also be largely or completely embedded in the opaque layer.

The first pane, the second pane, or the at least one thermoplastic intermediate layer can be clear and colorless, but also tinted, frosted, or colored. The total transmittance through the vehicle composite pane is, in a preferred embodiment, greater than 70%, in particular when the vehicle composite pane is a windshield. The term “total transmittance” is based on the process for testing the light permeability of motor vehicle windows specified by ECE-R 43, Annex 3, § 9.1. The first pane and the second pane can be made of non-tempered, partially tempered, or tempered glass. The thickness of the first pane and the second pane is typically from 0.3 mm to 5 mm, preferably from 1 mm to 3 mm, for example, 2.1 mm.

The vehicle composite pane is preferably curved in one or a plurality of spatial directions, as is customary for motor vehicle windows, with typical radii of curvature in the range from approx, 10 cm to approx. 40 m. The composite glass can, however, also be flat, for example, when it is intended as a pane for buses, trains, or tractors.

Preferably, the inlay element is arranged in an upper half, particularly preferably in an upper third, most particularly preferably in an upper fourth of the vehicle composite pane. Preferably, the inlay element is arranged horizontally substantially in the center of the vehicle composite pane.

In a preferred embodiment, the vehicle composite pane is a windshield.

In one embodiment, the vehicle composite pane is a windshield that is arranged mirror-symmetric along a center line, and the inlay element is arranged on the center line in the vicinity of the upper edge of the windshield.

“In the vicinity of the upper edge” means, in particular, that the distance between the inlay element and the upper edge is at most 30 mm, preferably at most 20 mm, particularly preferably at most 15 mm, most particularly preferably at most 10 mm.

In an advantageous embodiment of the invention, the transparent electrically heatable layer, the electrically heatable substrate layer, or the electrically heatable opaque layer is connected via bus bars to a voltage source. The bus bars are used to transfer electric power. Examples of suitable bus bars are known from DE 103 33 618 B3 and EP 0 025 755 B1.

The bus bars are advantageously produced by printing a conductive paste. The conductive paste preferably contains silver particles and glass frits. The layer thickness of the baked conductive paste is preferably from 5 μm to 20 μm.

In an alternative embodiment, thin and narrow metal foil strips or metal wires that preferably contain copper and/or aluminum are used as bus bars; used, in particular, are copper foil strips with a thickness of preferably 10 μm to 200 μm, for example, approx. 50 μm. The width of the copper foil strips is preferably 1 mm to 10 mm.

Usually used in the vehicle sector as a supply line for the contacting of bus bars in the interior of composite panes are foil conductors. Examples of foil conductors are described in DE 42 35 063 A1, DE 20 2004 019 286 U1, and DE 93 13 394 U1.

A further aspect of the invention is an arrangement comprising a vehicle composite pane according to the invention and an optical sensor applied thereon that is secured to the interior-side surface of the inner pane facing away from the intermediate layer and is directed toward the sensor window of the vehicle composite pane, i.e., toward the region of the cutout in the opaque layer or the electrically heatable opaque layer or to the not opaquely colored region of the transparent substrate layer. The detection beam path of the sensor thus runs through the cutout in the opaque layer or the electrically heatable opaque layer or through the not opaquely colored region of the transparent substrate layer. The optical sensor is preferably an optical camera, in other words, a camera with sensitivity in the visible spectral range, for example, a lane camera or a camera for an augmented reality head-up display.

The invention also relates to a method for producing a vehicle composite pane, at least comprising the following steps:
(a) Providing a first pane, a second pane, at least one thermoplastic intermediate layer, and an inlay element, at least comprising an opaque layer that has at least one cutout, one transparent substrate layer, and one transparent electrically heatable layer;
(b) Arranging the at least one thermoplastic intermediate layer and the inlay element between the first pane and the second pane; and
(c) Joining the first pane to the second pane via the at least one thermoplastic intermediate layer by lamination.

The arrangement of the opaque layer that has at least one cutout, the transparent substrate layer, and the transparent electrically heatable layer of the inlay element when providing the inlay element can be done manually or mechanically, for example, by means of a robot. The inlay element can be implemented as in the various embodiments described above. The layer sequence in the inlay element can be as described above in the various embodiments. As described above, the transparent substrate layer and the transparent electrically heatable layer can also be implemented in one piece as an electrically heatable transparent substrate layer. In the inlay element, the opaque layer and the transparent electrically heatable layer can also be implemented in one piece as an electrically heatable opaque layer having at least one cutout, and the transparent substrate layer is arranged over the entire surface directly adjacent the electrically heatable opaque layer and the at least one cutout; or the transparent substrate layer is arranged completely within the at least one cutout of the electrically heatable opaque layer.

The arrangement of the inlay element between the first pane and the second pane can be done manually or mechanically, for example, by means of a robot.

If the vehicle composite pane is to have a curve, as is customary in particular for passenger cars, the panes are subjected to a bending process before lamination, for example, by gravity bending, suction bending, and/or press bending. Typical bending temperatures are from 500° C. to 700° C.

Preferably, before lamination and before the optional bending, an opaque masking print is applied, in particular to the edge region of the first pane and/or the second pane. For this, a black or dark enamel is typically applied by screen printing and baked before lamination, in particular before bending or during bending.

The embodiments described above in connection with the vehicle composite pane apply in the same way to the method according to the invention.

The invention also relates to the use of a vehicle composite pane according to the invention as a windshield of a vehicle, preferably a motor vehicle.

The various embodiments of the invention can be implemented individually or in any combinations. In particular, the features mentioned above and explained in the following can be used not only in the combinations mentioned but also in other combinations or in isolation, without departing from the scope of the present invention.

In the following, the invention is explained in detail with reference to drawings and exemplary embodiments. The drawings are schematic representations and not to scale. The drawings in no way restrict the invention.

They depict:

FIG. 1 a plan view of an embodiment of the vehicle composite pane according to the invention,

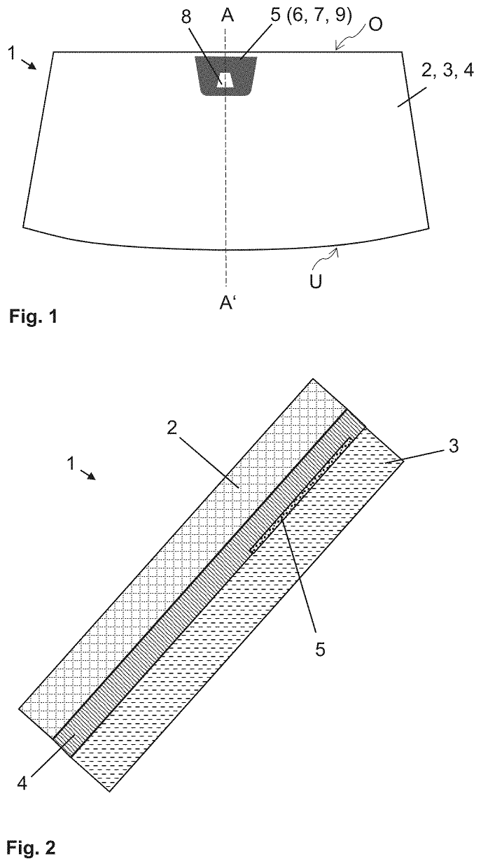

FIG. 2 a cross-section through the vehicle composite pane according to the invention of FIG. 1 along the line A-A,

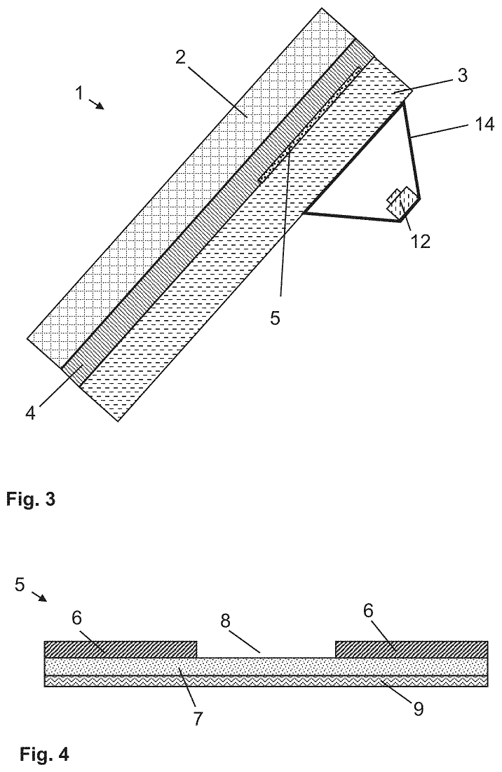

FIG. 3 a cross-section through another embodiment of a vehicle composite pane according to the invention along the line A-A,

FIG. 4 a cross-section through an embodiment of an inlay element,

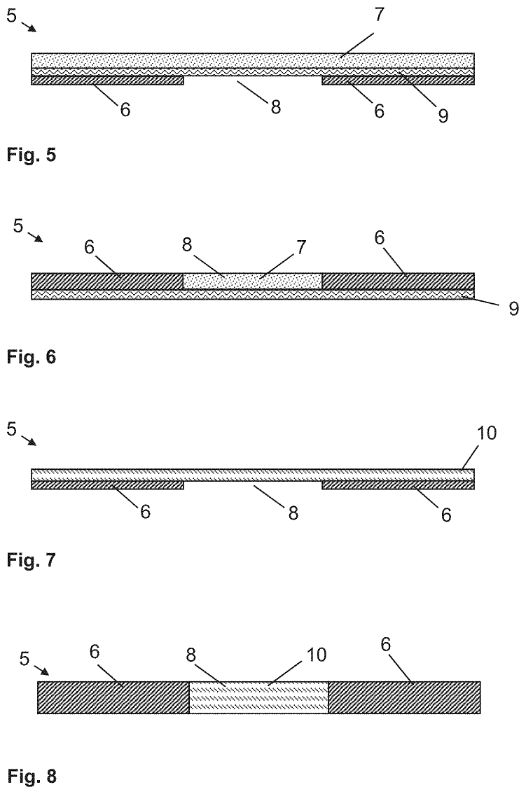

FIG. 5 a cross-section through another embodiment of an inlay element,

FIG. 6 a cross-section through another embodiment of an inlay element,

FIG. 7 a cross-section through another embodiment of an inlay element,

FIG. 8 a cross-section through another embodiment of an inlay element,

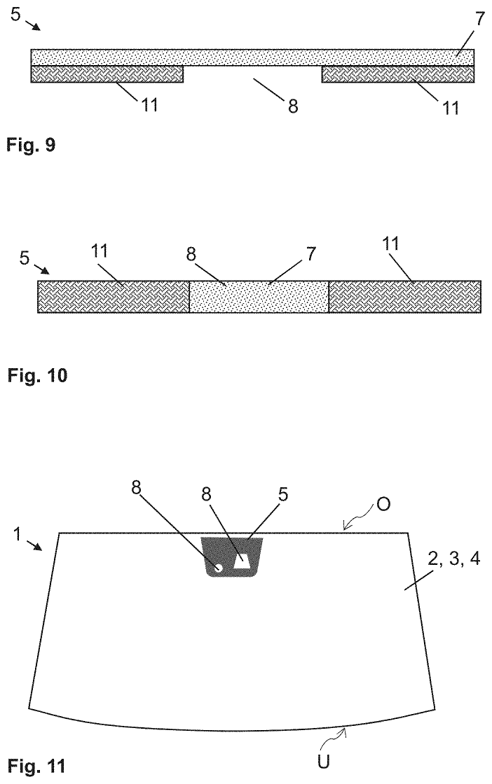

FIG. 9 a cross-section through another embodiment of an inlay element,

FIG. 10 a cross-section through another embodiment of an inlay element,

FIG. 11 a plan view of another embodiment of the vehicle composite pane according to the invention.

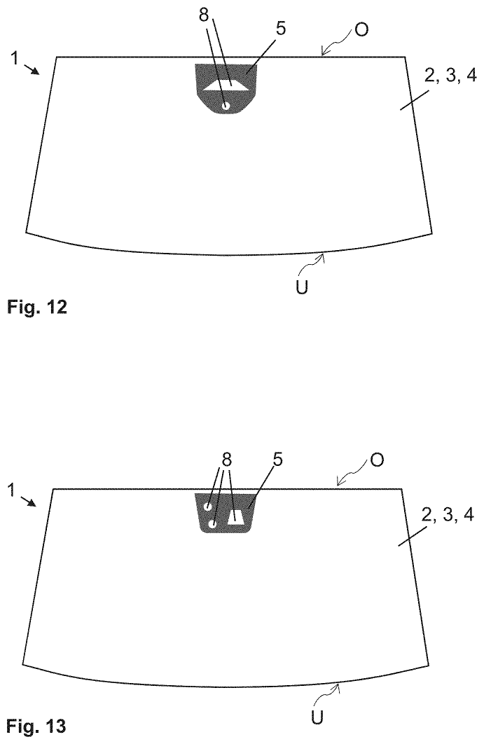

FIG. 12 a plan view of another embodiment of the vehicle composite pane according to the invention,

FIG. 13 a plan view of another embodiment of the vehicle composite pane according to the invention,

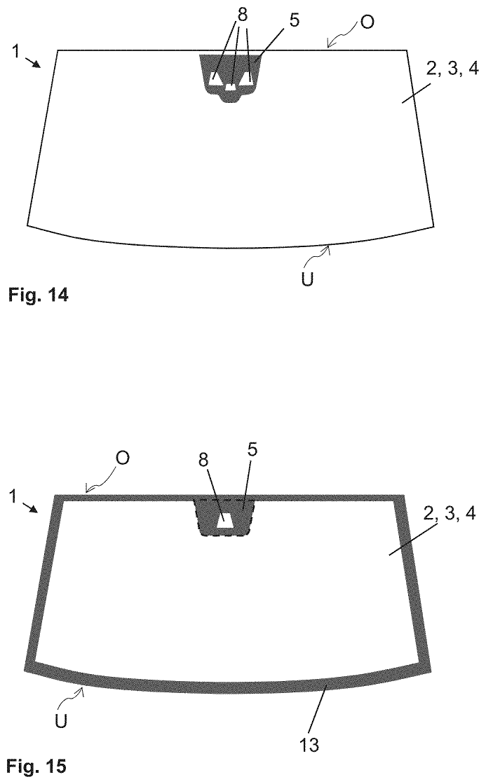

FIG. 14 a plan view of another embodiment of the vehicle composite pane according to the invention,

FIG. 15 a plan view of another embodiment of the vehicle composite pane according to the invention,

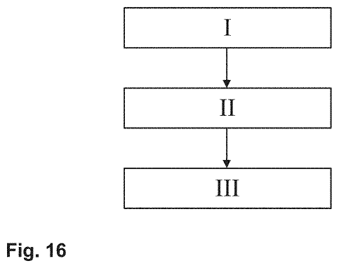

FIG. 16 a flow chart of an embodiment of the method according to the invention.

FIG. 1 depicts an embodiment of the vehicle composite pane 1 according to the invention, and FIG. 2 depicts the cross-section through the vehicle composite pane 1 according to the invention in accordance with FIG. 1 along the line A-A, which corresponds to the center line. The vehicle composite pane 1 depicted in FIG. 1 is mirror-symmetrical along the center line, and the inlay element 5 is arranged on the center line in the vicinity of the upper edge O. In the embodiment depicted in FIGS. 1 and 2, the vehicle composite pane 1 comprises a first pane 2 and a second pane 3 that are joined to one another, surface-to-surface via a thermoplastic intermediate layer 4. In the embodiment depicted in FIGS. 1 and 2, the first pane 2 is the outer pane; and the second pane 3, the inner pane. The first pane 2 and the second pane 3 are made of soda lime glass and have, for example, a thickness of 2.1 mm. Arranged between the second pane 3 and the thermoplastic intermediate layer 4 is an inlay element 5 that has a cutout 8. In the embodiment depicted in FIGS. 1 and 2, the inlay element 5 is arranged between the second pane 3 and the thermoplastic intermediate layer 4. The inlay element 5 can, however, also be arranged between the first pane 2 and the thermoplastic intermediate layer 4. In addition, the vehicle composite pane 1 according to the invention can also include more than one thermoplastic intermediate layer 4. In the embodiment depicted in FIGS. 1 and 2, the thermoplastic intermediate layer 4 is made of polyvinyl butyral (PVB) and is 0.76 mm thick. In the embodiment depicted in FIG. 2, the inlay element is constructed as shown in FIG. 4. In the embodiment depicted in FIGS. 1 and 2, the cutout 8 is trapezoidal and has an area of 35 cm². However, any other shape suitable fora sensor window is also possible. In the embodiment depicted in FIGS. 1 and 2, the inlay element 5 has a trapezoidal shape, wherein the corners pointing toward the lower edge are rounded. However, any other outer shape of the inlay element 5 suitable for masking a sensor is possible. In the embodiment depicted in FIGS. 1 and 2; the opaque layer 6 is dark gray. It can, however, also be any other color, for example, black. In the embodiment depicted in FIGS. 1 and 2, the second pane 3 is the inner pane, which faces the interior of the vehicle in the installed position.

The vehicle composite pane 1 has an upper edge O and a lower edge U. In the installed position, the upper edge O points upward toward the vehicle roof; the lower edge points, in the installed position, downward toward the engine compartment. The interior-side surface of the outer pane (first pane 2) is joined to the exterior side surface of the inner pane (second pane 3) via the thermoplastic intermediate layer 4. Customarily, the exterior-side surface of the outer pane is referred to as “side I”; the interior-side surface of the outer pane, as “side II”; the exterior-side surface of the inner pane as “side III”; and the interior-side surface of the inner pane as “side IV”.

FIG. 3 depicts another embodiment of a vehicle composite pane 1 according to the invention, which differs from the embodiment depicted in FIG. 2 only in that it additionally includes an optical sensor 12 that is mounted, on the interior side, on the second pane 3 implemented as the inner pane via a mount 14 and is directed toward the cutout 8. The optical sensor 12 is, for example, a lane camera. The detection direction of the optical sensor 12 is directed roughly horizontally forward outside the vehicle composite pane 1. Radiation that enters horizontally through the vehicle composite pane 1 in a so-called “sensor window” that corresponds to the region of the cutout 8 in the embodiment depicted in FIG. 3 is detected by the optical sensor 12.

FIG. 4 depicts the cross-section through an embodiment of an inlay element 5, i.e., the cross-section of an inlay element 5 in an embodiment of a vehicle composite pane 1 according to the invention. In the embodiment depicted in FIG. 4, the inlay element 5 comprises a transparent substrate layer 7; a transparent electrically heatable layer 9, and an opaque layer 6 that has a cutout 8. The transparent substrate layer 7 is arranged between the opaque layer 6 and the transparent electrically heatable layer 9. In the embodiment depicted in FIG. 4, the transparent substrate layer 7 is, for example, a PET film with a thickness of 100 μm; the transparent electrically heatable layer 9 is an electrically heatable ITO-coating with a thickness of 10 μm applied on the transparent substrate layer 7; and the opaque layer 6 is a PET film with a thickness of 125 μm. The transparent substrate layer 7, the transparent electrically heatable layer 9, and the opaque layer 6 with the cutout 8 have the same external dimensions.

FIG. 5 depicts the cross-section through another embodiment of an inlay element 5. In the embodiment depicted in FIG. 5, the inlay element 5 comprises a transparent substrate layer 7, a transparent electrically heatable layer 9, and an opaque layer 6 having a cutout 8. The transparent electrically heatable layer 9 is arranged between the opaque layer 6 and the transparent substrate layer 7. In the embodiment depicted in FIG. 5, the transparent substrate layer 7 is, for example, a PET film with a thickness of 100 μm; the transparent electrically heatable layer 9 is an electrically heatable silver coating with a thickness of 10 μm applied on the transparent substrate layer 7; and the opaque layer 6 is a PET film with a thickness of 125 μm. The transparent substrate layer 7, the transparent electrically heatable layer 9, and the opaque layer 6 with the cutout 8 have the same external dimensions.

FIG. 6 depicts the cross-section through another embodiment of an inlay element 5. In the embodiment depicted in FIG. 6, the inlay element 5 comprises a transparent substrate layer 7, a transparent electrically heatable layer 9, and an opaque layer 6 having a cutout 8. The transparent substrate layer 7 is arranged completely within the at least one cutout 8 of the opaque layer 6. The transparent substrate layer 7 has the same thickness as the opaque layer 6 and is, in the embodiment depicted in FIG. 6, surrounded thereby in a frame-like manner. The transparent electrically heatable layer 9 is, in the embodiment depicted in FIG. 6, arranged over the entire surface directly adjacent the opaque layer 6 and the transparent substrate layer 7. In the embodiment depicted in FIG. 6, the transparent substrate layer 7 is, for example, a PET film with a thickness of 150 μm; the transparent electrically heatable layer 9 is a graphene layer with a thickness of 20 μm; and the opaque layer 6 is a PET film with a thickness of 150 μm. Alternatively, it is also possible for the transparent substrate layer 7 and the opaque layer 6 to be implemented in one piece; and for the transparent substrate layer 7 to be opaquely colored in the regions marked with the reference character 6 in FIG. 6. A separate opaque layer 6 is unnecessary in these embodiments.

FIG. 7 depicts the cross-section through another embodiment of an inlay element 5. In the embodiment depicted in FIG. 7, the inlay element 5 comprises an opaque layer 6 having a cutout 8, and an electrically heatable transparent substrate layer 10 arranged directly adjacent thereto. Thus, in the embodiment depicted in FIG. 7, the transparent substrate layer 7 and the transparent electrically heatable layer 9 are present not as two separate layers but are implemented in one piece as the electrically heatable transparent substrate layer 10. In the embodiment depicted in FIG. 7, the electrically heatable transparent substrate layer 10 is made, for example, of an electrically conductive polymer, such as polyaniline, with a thickness of 100 μm; and the opaque layer 6 is a PET film with a thickness of 75 μm.

FIG. 8 depicts the cross-section through another embodiment of an inlay element 5. In the embodiment depicted in FIG. 8, the inlay element 5 comprises an opaque layer 6 having a cutout 8, and an electrically heatable transparent substrate layer 10 arranged completely within the cutout 8. The electrically heatable transparent substrate layer 10 is thus surrounded in a frame-like manner by the opaque layer 6. In the embodiment depicted in FIG. 8, the transparent substrate layer 7 and the transparent electrically heatable layer 9 are present not as two separate layers but are implemented in one piece as the electrically heatable transparent substrate layer 10. In the embodiment depicted in FIG. 8, the electrically heatable transparent substrate layer 10 is made, for example, of an electrically conductive polymer, such as polyaniline, with a thickness of 150 μm; and the opaque layer 6 is a PET film with a thickness of 150 μm.

FIG. 9 depicts the cross-section through another embodiment of an inlay element 5. In the embodiment depicted in FIG. 9, the inlay element 5 comprises a transparent substrate layer 7 and an electrically heatable opaque layer 11 arranged directly adjacent thereto. Thus, in the embodiment depicted in FIG. 9, the opaque layer 6 and the transparent electrically heatable layer 9 are present not as two separate layers but are implemented in one piece as the electrically heatable opaque layer 11. The electrically heatable opaque layer 11 has a cutout 8. In the embodiment depicted in FIG. 9, the electrically heatable opaque layer 11 is made, for example, of a colored electrically conductive polymer, such as polyaniline, with a thickness of 100 μm; and the transparent substrate layer 7 is a thin glass with a thickness of 0.1 mm. The transparent substrate layer 7 and the electrically heatable opaque layer 11 with the cutout 8 have the same external dimensions.

FIG. 10 depicts the cross-section through another embodiment of an inlay element 5. In the embodiment depicted in FIG. 10, the inlay element 5 comprises a transparent substrate layer 7 and an electrically heatable opaque layer 11. Thus, in the embodiment depicted in FIG. 10, the opaque layer 6 and the transparent electrically heatable layer 9 are present not as two separate layers but are implemented in one piece as an electrically heatable opaque layer 11. The electrically heatable opaque layer 11 has a cutout 8. The embodiment depicted in FIG. 10 differs from the embodiment of the inlay element 5 depicted in cross-section in FIG. 9 in particular in that the transparent substrate layer 7 is arranged completely within the cutout 8 of the electrically heatable opaque layer 11. The transparent substrate layer 7 has the same thickness as the electrically heatable opaque layer 11 and is surrounded thereby in a frame-like manner in the embodiment depicted in FIG. 10. In the embodiment depicted in FIG. 10, the electrically heatable opaque layer 11 is made, for example, of a colored electrically conductive polymer, such as, polyaniline, with a thickness of 125 μm; and the transparent substrate layer 7 is a PVB film with a thickness of 125 μm.

FIG. 11 depicts another embodiment of a vehicle composite pane 1 according to the invention. The vehicle composite pane 1 shown in FIG. 11 differs from the embodiment shown in FIG. 1 only in that the inlay element 5 has two cutouts 8, wherein one cutout 8 is trapezoidal and one cutout 8 is circular.

FIG. 12 depicts another embodiment of a vehicle composite pane 1 according to the invention. The vehicle composite pane 1 shown in FIG. 12 differs from the embodiment shown in FIG. 11 only in that the trapezoidal cutout 8 is larger and the cutouts 8 are not arranged side-by-side but, instead, are arranged one above the other. In addition, the outer shape of the inlay element 5 in the embodiment depicted in FIG. 12 differs from the outer shape of the inlay element 5 in the embodiment depicted in FIG. 11.

FIG. 13 depicts another embodiment of a vehicle composite pane 1 according to the invention. The vehicle composite pane 1 depicted in FIG. 13 differs from the embodiment depicted in FIG. 11 only in that the inlay element 5 has three cutouts 8, of which one is trapezoidal and two are circular.

FIG. 14 depicts another embodiment of a vehicle composite pane 1 according to the invention. This differs from the embodiment shown in FIG. 13 only in that the three cutouts 8 are trapezoidal and are arranged side-by-side and that, in the center, the inlay element 5 is extended in the direction of the lower edge U.

FIG. 15 shows another embodiment of a vehicle composite pane 1 according to the invention. The vehicle composite pane 1 shown in FIG. 15 differs from that shown in FIG. 1 only in that it additionally includes a peripheral masking print 13 made of enamel. The opaque layer 6 (not explicitly shown in FIG. 15) of the inlay element 5 and the peripheral masking print 13 have essentially the same optical density and are dark gray in the embodiment depicted in FIG. 15. To clarify where the inlay element 5 is arranged in the embodiment depicted in FIG. 15, it is indicated in FIG. 15 with a black dashed border. In the embodiment depicted in FIG. 15, the peripheral masking print 13 is applied only adjacent the outer edges of the vehicle composite pane 1. However, it is also possible fora masking print 13 to also be applied externally around the inlay element 5.

FIG. 16 shows the flow chart of a method according to the invention for producing a vehicle composite pane 1 according to the invention. In a first step a first pane 2, a second pane 3, at least one thermoplastic intermediate layer 4, and an inlay element 5, at least comprising an opaque layer 6 that has at least one cutout 8, a transparent substrate layer 7, and a transparent electrically heatable layer 9 are provided. In a second step 11, the at least one thermoplastic intermediate layer 4 and the inlay element 5 are arranged between the first pane 2 and the second pane 3. In a third step III, the first pane 2 is joined to the second pane 3 via the at least one thermoplastic intermediate layer 4 by lamination.

### LIST OF REFERENCE CHARACTERS

1 vehicle composite pane
2 first pane
3 second pane
4 thermoplastic intermediate layer
5 inlay element
6 opaque layer
7 transparent substrate layer
8 cutout
9 transparent electrically heatable layer
10 electrically heatable transparent substrate layer
11 electrically heatable opaque layer
12 optical sensor
13 masking print
14 mount
O upper edge/roof edge of the vehicle composite pane
U lower edge/engine edge of the vehicle composite pane

1. Vehicle composite pane, comprising:
a first pane and a second pane, which are joined to one another via at least one thermoplastic intermediate layer, and
an inlay element, at least comprising an opaque layer that has at least one cutout, a transparent substrate layer, and a transparent electrically heatable layer, wherein the inlay element is arranged between the first pane and the second pane.

2. The vehicle composite pane according to claim 1, wherein in the inlay element, the transparent substrate layer is arranged between the opaque layer and the transparent electrically heatable layer.

3. The vehicle composite pane according to claim 1, wherein in the inlay element, the transparent electrically heatable layer is arranged between the transparent substrate layer and the opaque layer.

4. The vehicle composite pane according to claim 1, wherein in the inlay element, the transparent substrate layer is arranged completely within the at least one cutout of the opaque layer, and the transparent electrically heatable layer is arranged, over an entire surface, directly adjacent the opaque layer) and the transparent substrate layer.

5. The vehicle composite pane according to claim 1, wherein in the inlay element, the transparent substrate layer, and the transparent electrically heatable layer are implemented in one piece as an electrically heatable transparent substrate layer.

6. The vehicle composite pane according to claim 1, wherein in the inlay element, the opaque layer, and the transparent electrically heatable layer are implemented in one piece as an electrically heatable opaque layer that has at least one cutout; and the transparent substrate layer is arranged, over an entire surface, directly adjacent the electrically heatable opaque layer and the at least one cutout or is arranged completely within the at least one cutout of the electrically heatable opaque layer.

7. The vehicle composite pane according to claim 1, wherein the at least one cutout is a sensor window for an optical sensor.

8. The vehicle composite pane according to claim 1, wherein the opaque layer contains or is made of poly ethylene terephthalate or polyethylene, preferably PET.

9. The vehicle composite pane according to claim 1, wherein the transparent substrate layer includes a thermoplastic or a thermosetting plastic or is a glass layer that has a thickness less than or equal to 0.5 mm.

10. The vehicle composite pane according to claim 1, wherein the transparent electrically heatable layer is an electrically heatable coating, a carbon-containing layer, or a metallic layer, or contains or is made of an electrically conductive polymer.

11. The vehicle composite pane according to claim 5, wherein the electrically heatable transparent substrate layer or the electrically heatable opaque layer contains or is made of an electrically conductive polymer.

12. The vehicle composite pane according to claim 1, wherein the opaque layer or the electrically heatable opaque layer is, at least in sections, transparent to infrared radiation with a wavelength in the range between 800 nm and 1100 nm.

13. The vehicle composite pane according to claim 1, wherein the vehicle composite pane is a windshield that is mirror-symmetrical along a center line, and the inlay element is arranged on the center line in the vicinity of the upper edge of the windshield.

14. Method for producing a vehicle composite pane according to claim 1, the method comprising:
(a) providing a first pane, a second pane, at least one thermoplastic intermediate layer, and an inlay element, at least comprising an opaque layer that has at least one cutout, a transparent substrate layer, and a transparent electrically heatable layer;
(b) arranging the at least one thermoplastic intermediate layer and the inlay element between the first pane and the second pane; and
(c) joining the first pane to the second pane via the at least one thermoplastic intermediate layer by lamination.

15. A method comprising forming a windshield of a vehicle with a vehicle composite pane according to claim 1.

16. The vehicle composite pane according to claim 8, wherein the opaque layer contains or is made of polyethylene terephthalate (PET).
